(19) United States
(12) Patent Application Publication
(10) Pub. No.: US 2007/0271439 A1
(43) Pub. Date: Nov. 22, 2007

(54) METHOD AND DEVICE FOR MANAGING A MEMORY ACCESS LOOK-UP TABLE

(75) Inventors: Maher Mastouri, Bizerte (TN); Hubert Rousseau, Marseille (FR)

Correspondence Address: SEED INTELLECTUAL PROPERTY LAW GROUP PLLC, 701 FIFTH AVENUE, SUITE 5400, SEATTLE, WA, 98104-7092, US

(73) Assignees: STMICROELECTRONICS SA, Montrouge (FR); STMICROELECTRONICS SA TUNISIE, Ariana (TN)

(21) Appl. No.: 11/747,083

(22) Filed: May 10, 2007

(30) Foreign Application Priority Data
May 11, 2006 (FR) 06/04214

(51) Int. Cl. G06F 12/00

(52) U.S. Cl. 711/202

(57) ABSTRACT

A method for constituting a look-up table of logic addresses and physical addresses of blocks of a memory is provided. The memory saving for each block a state of the block, and for each used block the logic address of the block, the method involving: reading the state of each block in the memory, storing the physical address of each block in the used state in an address field of a line selected in the table from the logic address of the block read in the memory, for each block in the free state in the memory, storing the physical address of the block, while marking a line of the table, selected from the physical address of the block, and storing an address corresponding to each marked line of the table, in a free address field of the table.

### BACKGROUND OF THE INVENTION

1. Field of the Invention

The present invention relates to the management of a memory, and in particular, of a non-volatile Flash-type memory with NAND gates.

2. Description of the Related Art

FIG. 1 represents the organization of a Flash-type memory. In FIG. 1, the memory MEM is divided into several blocks B0, B1, B2 . . . , Bn. Each block is itself divided into pages PG0, PG1, PG2, etc., PGm. Each page comprises a data zone DT allowing data to be stored, and a control zone CTL allowing error correction codes and state data of the block to be stored. The memory MEM is block-erasable, and page-programmable and readable.

FIG. 2 represents the content of each page PGk and in particular of the control zone CTL. The control zone CTL stores an error correction code ECC allowing errors in the data stored in the data zone DT to be corrected, an indicator of the free or used state of the block UB, an indicator of the good or defective state of the block BB, an indicator of the valid or invalid state of the block VD, and a logic address LAD of the block when the latter is in the used state. The indicators UB, BB and VD and the logic address LAD are repeated in each page of the block.

FIG. 3 shows a mode for accessing the memory MEM. To access a block Bj of a zone Zi of the memory MEM, a central processing unit CPU uses a look-up table LUT supplying a block physical address PAD according to a logic address LAD.

The logic address LAD that is supplied by the central processing unit CPU enables a line of the table LUT to be addressed. Each line of the table LUT comprises an address field saving the physical address PAD of a block corresponding to a logic address.

So as not to penalize the memory MEM access times, the table LUT is stored in a fast-access memory that is generally volatile (for example of RAM type). It must therefore be rebuilt upon each switch on. For this purpose, the microprocessor μP executes an initialization procedure allowing the table to be constituted, this program classically comprising the following steps.

In a first phase, the microprocessor successively reads the control data CTL of the blocks Bj of the memory zone Zi. If, according to the indicator BB, the block is defective, its physical address PAD and its state indicators are stored at the end of the table LUT, starting with the last line of the table. If, according to the indicators UB, VD and BB, the block is good, valid and used, its physical address PAD and its state indicators are stored in the table LUT at the logic address LAD read in the control data CTL of the block.

In a second phase, the lines of the table left free between the lines of the table used for the busy blocks are used to reference the free blocks of the zone Zi. For this purpose, the memory MEM must be read a second time to search for the free blocks, which is costly in terms of processing time.

To accelerate the initialization procedure, it is possible to store the physical addresses of the free blocks during the first phase. For this purpose, a second temporary table of the same size as the table LUT must be provided. Although it is faster, this solution is more costly in terms of required fast-access memory size.

### BRIEF SUMMARY OF THE INVENTION

Thus, in one embodiment, the constitution of the look-up table of the physical addresses and the logic addresses of the blocks of the memory is optimized, both as regards to the duration of the processing and the memory space necessary for the processing.

In one embodiment, a single reading of the memory is performed to store the physical addresses both of the used blocks and of the free blocks. For this purpose, each line of the look-up table the address of which corresponds to the physical address of a free block is marked to store the physical addresses of the unused blocks of the memory. The physical addresses of the unused blocks are then determined by the addresses of the marked lines.

More particularly, in one embodiment, a method is provided for constituting a look-up table of logic addresses and physical addresses of blocks of a memory, the memory saving for each block a state of the block, and for each used block the logic address of the block, the method comprising steps of reading in the memory the state of each block, and storing the physical address of each block in the used state in an address field of a line of the table, selected from the logic address of the block read in the memory.

According to one embodiment, the method comprises steps of:
storing the physical address of each block in the free state in the memory, while marking a line of the table, selected from the physical address of the block in the memory, and
for each block in the free state, storing an address corresponding to each marked line of the table, in a free address field of the table.

According to one embodiment, a line of the table is marked by changing the state of a free field of the line.

According to one embodiment, the method comprises a step of initializing the table involving changing the state of the free field of all the lines of the table, and a step of initializing the free field of lines of the table selected from the physical addresses of the blocks in a defective or used state.

According to one embodiment, the method comprises steps of:
searching for the marked lines of the table, and
for each marked line, searching for a line of the table the address field of which is free, writing an address corresponding to the marked line in the free address field of the line found, and removing the marking from the marked line.

According to one embodiment, each line of the table comprises a state field to store the state of a block the physical address of which in the memory is supplied by the address field of the line.

According to one embodiment, the physical address of each block in the defective state is stored at the end of the table.

According to one embodiment, the memory comprises several memory zones, each memory zone being associated with a look-up table of the logic addresses and the physical addresses of blocks belonging to the memory zone.

According to one embodiment, the look-up table of a memory zone is constituted upon the initialization of a system comprising the memory.

According to one embodiment, the look-up table of a memory zone is constituted upon an access to the memory zone.

In one embodiment, a system is provided comprising a central processing unit and a memory comprising memory blocks likely to be defective, the memory saving for each block a state of the block, and for each used block the logic address of the block, the central processing unit accessing the memory using a look-up table of the logic addresses and physical addresses of the blocks in the memory, the central processing unit comprising means for reading in the memory the state of each block, and means for storing the physical address of each used block in an address field of a line of the table, selected from the logic address of the block read in the memory.

According to one embodiment, the processing unit comprises:
means for storing the physical address of each block in the free state in the memory, while marking a line of the table, selected from the physical address of the block in the memory, and
means for storing for each block in the free state, an address corresponding to each marked line of the table, in a free address field of the table.

According to one embodiment, each line of the table comprises a free field used to mark the lines of the table corresponding to the physical addresses of the blocks in the free state.

According to one embodiment, the central processing unit comprises means for marking all the lines of the table by changing the state of the free field of all the lines of the table, and means for initializing the free field of lines of the table selected from the physical addresses of blocks in a defective or used state.

According to one embodiment, the central processing unit comprises means for:
searching for the marked lines of the table, and
for each marked line, searching for a line of the table the address field of which is free, writing an address corresponding to the line marked in the free address field of the line found, and removing the marking from the marked line.

According to one embodiment, each line of the table comprises a state field to store the state of a block the physical address of which in the memory is supplied by the address field of the line.

According to one embodiment, the physical address of each block in the defective state is stored at the end of the table.

According to one embodiment, the memory comprises several memory zones, each memory zone being associated with a look-up table of the logic addresses and the physical addresses of the blocks belonging to the memory zone.

According to one embodiment, the look-up table of a memory zone is constituted upon the initialization of the system.

According to one embodiment, the look-up table of a memory zone is constituted upon an access to the memory zone.

According to one embodiment, the memory is a flash-type memory with NAND gate.

According to one embodiment, the system comprises a fast-access memory saving the look-up table.

According to one embodiment, the processing unit and the memory are integrated into a microcontroller.

### BRIEF DESCRIPTION OF THE SEVERAL VIEWS OF THE DRAWINGS

These and other features and advantages of the present invention will be presented in greater detail in the following description of an embodiment of the present invention, given in relation with, but not limited to the following figures, in which:

FIG. 1 already described represents in block form the organization of a memory according to one embodiment.

FIG. 2 already described represents the structure of a page of the memory.

FIG. 3 already described shows in block form a mode for accessing the memory.

FIG. 4 represents in block form a system implementing the method according to one embodiment.

FIG. 5 represents in block form the organization of a memory according to one embodiment.

FIG. 6 represents the structure of a look-up table.

FIG. 7 represents the structure of a line of a look-up table used according to one embodiment to access the memory.

FIG. 8 is a flowchart showing the steps of the method according to one embodiment.

FIG. 9 represents an example of content of a zone of the memory to show the method according to one embodiment.

FIGS. 10a to 10c represent the content of the look-up table at different steps of the method according to one embodiment.

FIG. 11 is a flowchart showing another embodiment of the method.

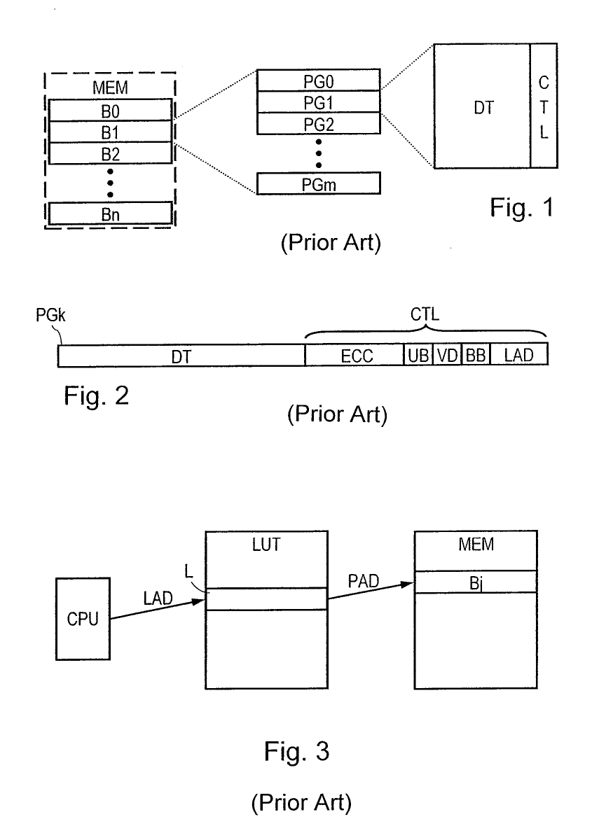

### DETAILED DESCRIPTION OF THE INVENTION

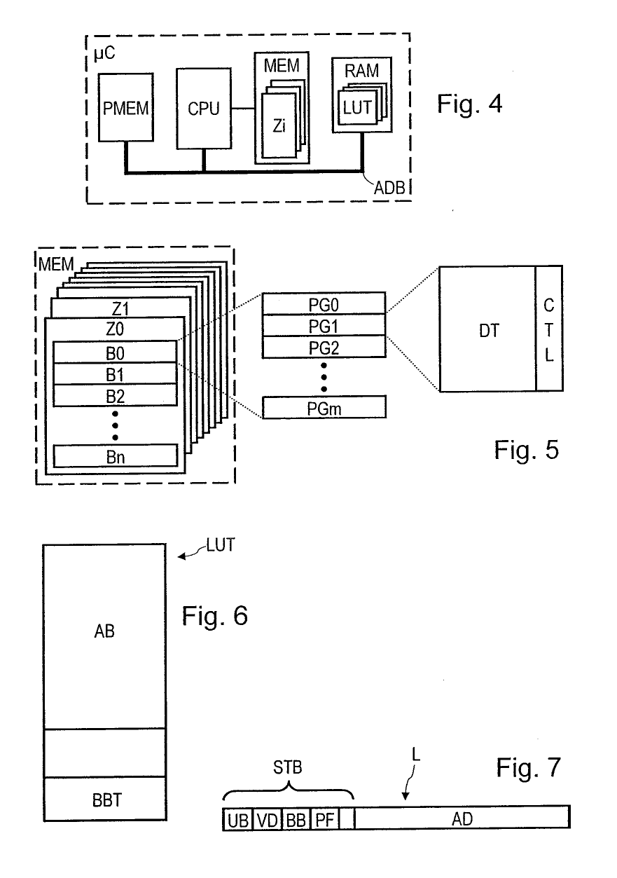

FIG. 4 represents a system μC implementing the method according to one embodiment. The system μC comprises a central processing unit CPU, one or more non-volatile memories MEM, PMEM and one or more fast-access memories RMEM. The non-volatile memories comprise for example a program memory PMEM and a mass memory MEM. The central processing unit CPU, the non-volatile memories PMEM and the fast-access memory RMEM are interconnected by a data and address bus ADB. The memory MEM is connected to the central processing unit. The central processing unit is driven by a program stored in the program memory PMEM and possibly in the mass memory MEM.

The entire system can be integrated into a microcontroller. The memory MEM is for example of Flash type with NAND gates. The program memory is for example of ROM type. The fast-access memory RMEM is for example of RAM type. The system μC is for example a USB key integrating a mass memory, or more generally a system integrating a Flash memory.

FIG. 5 represents the organization of the memory MEM. In FIG. 5, the memory MEM is divided into several blocks B0, B1, B2 . . . , Bn (Bj, j being a whole number varying from 0 to n). Each block is itself divided into pages PG0, PG1, PG2, . . . , PGm (PGk, k being a whole number varying from 0 to m). Each page comprises a data zone DT allowing data to be stored, and a control zone CTL allowing error correction codes and state data of the block to be stored. The memory MEM is block-erasable Bj, and page-programmable and readable PGk.

FIG. 6 represents the organization of a look-up table LUT that is generally used for a Flash memory with NAND gates as represented in FIG. 5. The table LUT comprises a zone AB located at the start of the table, gathering the physical addresses and the state information of the used blocks of the memory zone, and a zone BBT located at the end of the table, gathering the physical addresses and the state information of the defective blocks of the memory zone.

The size of the look-up table LUT is advantageously reduced by dividing the memory MEM into zones Z1, Z2, Z3, . . . , ZI (Zi, i being a whole number varying from 0 to p) in which the blocks Bj of the memory are spread (FIGS. 4 and 5). Each zone Zi has its own look-up table LUT the number of lines of which corresponds to the number of blocks Bj in the zone Zi.

FIG. 7 represents the content of a line L of a look-up table LUT according to one embodiment, used to access a memory such as the one represented in FIG. 5. Each line L of the table LUT is addressed by the central processing unit CPU (FIG. 4) by an address and comprises an address field AD saving the physical address PAD of a block Bj of the memory MEM (FIG. 5). Each line of the table LUT also comprises state fields STB saving the state indicators of the block located at the physical address given by the address field AD. The state indicators stored in the fields STB correspond to the state indicators UB, VD, BB stored in the control zone CTL of the block Bj (FIG. 5). Thus, the field STB comprises a free or used state indicator of the block UB, a good or defective state indicator of the block BB, and a valid or invalid state of the block VD.

According to one embodiment, each line L of the table LUT also stores a free block indicator PF provided in a free zone of the line. The indicator PF is used to indicate whether or not the block Bj the physical address of which corresponds to the address of the line in the table LUT is free.

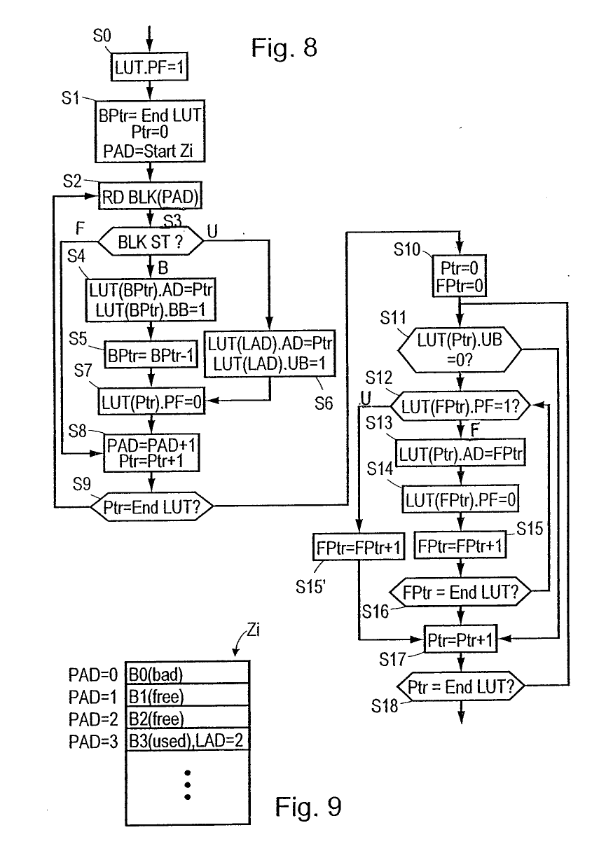

FIG. 8 represents the different steps of the method according to one embodiment executed by the unit CPU. The method according to one embodiment enables a look-up table LUT of logic addresses LAD and physical addresses PAD of blocks Bj of a memory zone Zi of the memory MEM to be constituted.

The method according to one embodiment comprises a first phase of initializing the table LUT comprising a step S0 during which all the lines of the table are initialized to 0 except for the field PF of each line that is set to 1.

The method according to one embodiment comprises a second phase of reading the state of the blocks Bj in the memory zone Zi. The second phase comprises steps S1 to S9. Step S1 involves initializing pointers. Thus, during this step, a pointer of defective blocks BPtr is initialized to the address of the end of the table LUT. A pointer Ptr is initialized to 0 (to the address of the start of the table LUT), and a pointer LAD is initialized to the physical address of the first block B0 of the zone Zi.

In the next step S2, the control zone CTL of the block Bj located at the address PAD is read. In the next step S3, the free or used state indicator UB, the good or defective state indicator BB, and the valid or invalid state indicator VD of the zone CTL read are tested. If, according to the state indicators, the block Bj is defective, steps S4 and S5 are executed. If the block is a free block, the processing continues to step S8.

If the block is used, step S6 is executed. In step S4, the line located at the address of the table LUT indicated by the pointer BPtr is addressed. The address field AD of the addressed line receives the physical address of the block Bj. The state indicator BB of the field STB of the addressed line is set to 1. In step S5, the pointer BPtr is decremented by 1. Thus, the defective blocks are referenced at the end of the table LUT moving up to the start of the table.

In step S6 (case in which the block at the address PAD is used), the line located at the logic address stored in the field LAD of the block Bj located at the address PAD is addressed. The address field AD of the addressed line receives the value of the pointer Ptr, and the field UB is set to 1.

Step S7 is executed following step S5 or S6. In step S7, the line of the table LUT located at the address Ptr is addressed. The field PF of the addressed line of the table LUT is set to 0. In the next step S8, the pointers PAD and Ptr are incremented by 1. In the next step S9, if the pointer PAD has not reached the end of the memory zone Zi (or if the pointer Ptr has reached the end of the table LUT), steps S2 to S9 are executed again.

During the phase of reading the state of the blocks in the memory MEM, the table LUT has been accessed using as address both the logic address of the blocks for the used blocks, and the physical address of the blocks to locate the physical address of the blocks in the free state. A line of the table can therefore supply both information concerning a used block (physical address and state), and information (physical address) concerning a free block.

If the end of the memory zone Zi is reached, a third phase of processing the free blocks is executed. The third phase comprises steps S10 to S18. The first step S10 initializes pointers Ptr and FPtr to 0. In the next step S11, the line of the table LUT located at the address Ptr is addressed. If the field UB of the addressed line is on 1 (unused block), steps S12 to S17 are executed, otherwise only step S17 is executed.

In step S12, the line of the table LUT located at the address FPtr is addressed. If the field PF of the addressed line is on 1 (indicating the presence of a free block at the address FPtr), steps S13 to S16 are executed, otherwise only step S15′ is executed.

In step S13, the line of the table LUT located at the address Ptr is addressed. The value of the pointer FPtr is written in the address field AD of the addressed line. In the next step S14, the line of the table LUT located at the address FPtr is addressed. The field PF of the addressed line is set to 1. In the next step S15, the pointer FPtr is incremented by 1. In step S15′, the pointer FPtr is also incremented by 1. In step S16, if the pointer FPtr has not reached the end of the table LUT, steps S12 to S16 are executed again, otherwise the next step S17 is executed.

Step S17 is also executed following step S15′. In step S17, the pointer Ptr is incremented by 1. In the next step S18, if the pointer Ptr has not reached the end of the table LUT, steps S11 to S18 are executed again.

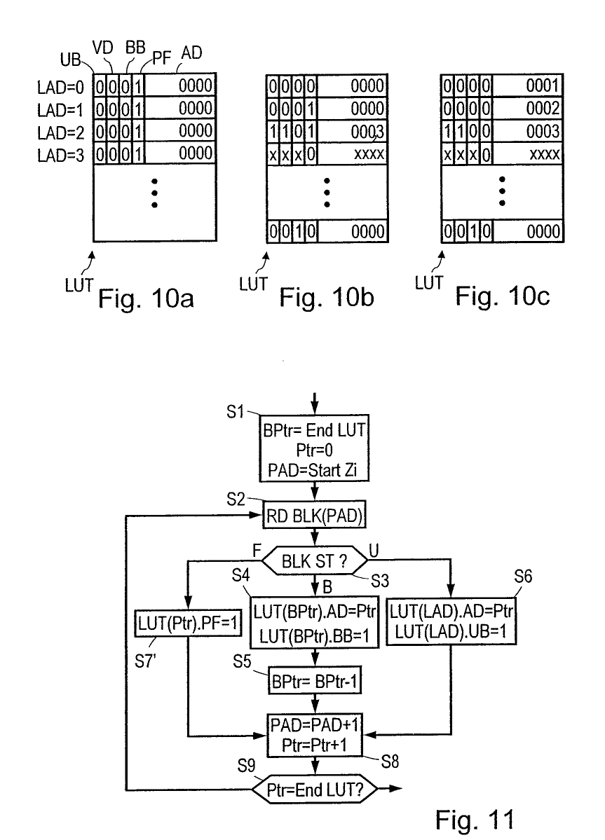

FIGS. 9 and 10a to 10c show the operation of the method according to one embodiment on an example of content of the zone Zi.

FIG. 9 represents an example of content of a zone Zi of the memory MEM. The zone Zi comprises a defective block B0 at the physical address 0, two free blocks B1, B2 at the physical addresses 1 and 2, and at the physical address 3, a used block B3 associated with a logic address 2.

FIGS. 10a to 10c represent the content of the table LUT at the end of each of the first phase (step S0), second phase (steps S1 to S9), and third phase (steps S10 to S18). In FIG. 10a, the table LUT is initialized to a state in which all the lines of the table are on 0 except for the field PF of each line that is on 1.

In FIG. 10b, the first defective block B0 is referenced at the last line of the table LUT: the field AD of the last line of the table stores the address of the block B0, i.e., 0. The last line also stores the state information of the block B0: the field BB is on 1 and the fields UB and VD are on 0. The field PF of the line of the table at the address 0 corresponding to the physical address of the block B0 has been set to 0 to indicate that the block at the physical address 0 is not free.

The physical addresses 1, 2 of the free blocks B1, B2 are stored in the table LUT by the fields PF on 1 at the lines of the table addressed by the physical address, i.e., the lines 1 and 2 of the table. The block B3 is referenced at the line of the table addressed by the logic address stored for the block B3, i.e., the address 2. The line of the table at the address 2 also stores the state information of the block B3: the fields UB and VD of the line 2 of the table are on 1 and the field BB is on 0. The field PF of the line of the table at the address 3 corresponding to the physical address of the block B3 has been set to 0. The values of the fields UB, VD and AD of the line at the address 3 of the table LUT at the end of the second phase depend on the existence of a used block associated with the logic address 3.

At the end of the second phase, the lines 0 and 1 of the table LUT are therefore free: they do not reference any block Bj of the memory MEM.

FIG. 10c represents the table LUT at the end of the third phase. The addresses of the lines of the table LUT (in the state in FIG. 10b) the fields PF of which are on 1 give the physical addresses of the free blocks Bj. The blocks B1, B2 at the physical addresses 1 and 2 are therefore free in the memory zone Zi. These blocks are referenced in the table at the first two free lines of the table LUT: the address field AD of the line 0 contains the physical address 1, and the address field of the line 1 contains the physical address 2. In each of the lines 0 and 1, the fields UB and BB are on 0 (free and good block), and the field VD is on 0 (valid block). Furthermore, all the fields PF of the table are on 0.

The values of the fields UB, VD and AD of the line 3 of the table LUT at the end of the third phase depend on the existence of a used block associated with the logic address 3.

FIG. 11 represents another embodiment of the first and second phases of the method according to one embodiment. The third phase is identical to the one shown in FIG. 8. In FIG. 11, the method according to one embodiment does not comprise any phase of initializing the table LUT (step S0) if the latter is entirely on 0 upon the switching on of the system. The second phase comprises the same steps S1 and S3 as the second phase shown in FIG. 8. If the block is defective, steps S4 and S5 described previously are executed. If the block is used, step S6 described above is executed. If the block is free, step S7′ is executed. Step S7′ involves addressing the table using the pointer Ptr corresponding to the physical address for reading the memory and setting to 1 the field PF of the addressed line of the table.

Step S7 is removed. Steps S8 and S9 are therefore executed following steps S5, S6 and S7′.

To execute a read command for reading a page PGk at an address of the memory MEM, the central processing unit CPU first of all executes an addressing procedure. The addressing procedure involves determining the number of the zone Zi in which the page to be read is located, according to an address belonging to the space addressable by the central processing unit CPU. Thus, during the addressing procedure, an address of the space addressable by the unit CPU can be broken down into a zone number Zi, a logic address LAD of block Bj in the zone, and a page number PGk. Then, the unit CPU determines whether or not a look-up table LUT has been constituted for the zone Zi to be accessed. If the table has not yet been constituted, the unit CPU implements the method according to one embodiment for example by executing the procedure described with reference to FIG. 8 and/or 11. Once the table LUT is constituted for the zone Zi, the unit CPU searches in the table LUT for the state of the block Bj to be read, by addressing the table using the logic address LAD of the block. If the block is in the free or used and invalid state, the unit CPU sends back, in response to the read command, a blank page (for example equal to 0XFF). If the addressed line in the table LUT corresponds to a used and valid block, the unit CPU reads the physical address PAD of the block in the field AD of the addressed line in the table LUT. Using the zone number Zi, the physical address PAD of the block and the number of the page to be read, the unit CPU determines the parameters for accessing the page in the memory MEM.

The unit CPU then accesses the page PGk in the memory, and the error correction code ECC (FIG. 2), and checks whether the content of the page read is correct or can be corrected using the code ECC. If the content of the page read is correct or can be corrected, the content of the page is supplied by the unit CPU in response to the read command. In the opposite case, the unit CPU responds to the read command by supplying an error message.

To process a command for writing a block at an address of the memory MEM, the central processing unit CPU executes an addressing procedure to determine a number of a memory zone Zi in which the block to be written is located and the logic address LAD of the block in the memory zone. As above, if the table LUT of the zone Zi is not yet constituted, the unit CPU constitutes the table, and selects a line of the table LUT using the logic address of the block to be written. The unit CPU then determines the state of the block to be accessed using the fields UB and VD of the selected line. If the block to be accessed is free, the block to be written is written directly at the physical address PAD of the block stored in the field AD of the selected line of the table LUT.

If the block is used, the unit CPU searches in the table LUT for a line corresponding to a free block (field UB on 0) and stores the physical address appearing in the line found. This physical address of a free block will be used later to carry out the operation of writing the block to be written in the memory MEM. Then, the content of the addressed line is transferred by the unit CPU to the line found by setting the field VD to invalid. The line found, thus marked invalid, then references a block that must be erased before being in the free state again. The unit CPU writes in the field AD of the addressed line the physical address of the free block it has read in the line found. Then it updates the field UB of the addressed line to indicate that the block is used. The unit CPU then commands the writing of the block in the memory MEM at the physical address of the free block.

The lines marked invalid in the table LUT are changed later to reference a free block after erasing the block in the memory MEM at the physical address contained in the field AD. The blocks marked invalid in the table LUT can be erased by the unit CPU for example in the background.

Dividing the memory into zones Zi, and therefore providing several tables LUT with one table for each zone, enables the time for accessing the memory upon the switching on of the system to be reduced. Indeed, it is not necessary to have constituted a look-up table for the entire memory MEM so that a write or read command can be executed.

It will be understood by those skilled in the art that various alternative embodiments and applications of the present invention are possible. In particular, it is not necessary for the look-up table LUT to have a free field to mark the lines of the table corresponding to the physical addresses of the free blocks of the memory. This marking can indeed be done in a binary word distinct from the table, comprising one bit for each line of the table. Although less optimal than the solution described previously, this solution is little disadvantageous in terms of memory space used, as the size of the binary word is considerably smaller than that of the table LUT.

It is not essential either to store the physical addresses of the defective blocks, or to store these physical addresses at the end of the look-up table. Indeed, the state of each block is stored in the memory MEM. It is therefore possible to locate the defective blocks by reading the state indicators stored in the memory. Furthermore, the physical addresses of the defective blocks can be stored in another table.

The free or used state of the blocks is not necessarily stored in the look-up table either. It can be stored in another table addressed by the logic or physical address of the block.

Furthermore, the present invention does not only apply to Flash memories with NAND gates. It can be applied more generally to any memory subject to memory cell faults and thus requiring defective block management, and/or a memory in which the minimal size of a reading zone is smaller than the minimal size of a writing or programming zone.

1. A method comprising:
saving for each block of a memory a state of the block, and for each used block a logic address of the block;
reading in the memory the state of each block;
storing a physical address of each block in a used state in an address field of a line of a look-up table, selected from the logic address of the block read in the memory;
storing the physical address of each block in a free state in the memory, selected from the physical address of the block in the memory;
marking a line of the table for each block in the free state in the memory; and
for each block in the free state, storing an address corresponding to each marked line of the table, in a free address field of the table.

2. A method according to claim 1, wherein a line of the table is marked by changing the state of a free field of the line.

3. A method according to claim 2, comprising a step of initializing the table involving changing the state of the free field of all the lines of the table, and a step of initializing the free field of lines of the table selected from the physical addresses of the blocks in a defective or used state.

4. A method according to claim 1, comprising steps of:
searching for the marked lines of the table, and
for each marked line, searching for a line of the table the address field of which is free, writing an address corresponding to the marked line in the free address field of the line found, and removing the marking from the marked line.

5. A method according to claim 1, wherein each line of the table comprises a state field to store the state of a block the physical address of which in the memory is supplied by the address field of the line.

6. A method according to claim 1, wherein the physical address of each block in a defective state is stored at the end of the table.

7. A method according to claim 1, wherein the memory comprises several memory zones, each memory zone being associated with a look-up table of the logic addresses and the physical addresses of blocks belonging to the memory zone.

8. A method according to claim 7, wherein the look-up table of a memory zone is constituted upon the initialization of a system comprising the memory.

9. A method according to claim 7, wherein the look-up table of a memory zone is constituted upon an access to the memory zone.

10. A system comprising:
a central processing unit;
a memory comprising memory blocks likely to be defective, the memory saving for each block a state of the block, and for each used block the logic address of the block, the central processing unit accessing the memory using a look-up table of the logic addresses and physical addresses of the blocks in the memory,
wherein the central processing unit comprises:
means for reading in the memory the state of each block;
means for storing the physical address of each used block in an address field of a line of the table, selected from the logic address of the block read in the memory;
means for storing the physical address of each block in a free state in the memory, selected from the physical address of the block in the memory;
means for marking a line of the table for each block in the free state in the memory; and
means for storing for each block in the free state, an address corresponding to each marked line of the table, in a free address field of the table.

11. A system according to claim 10, wherein each line of the table comprises a free field used to mark the lines of the table corresponding to the physical addresses of the blocks in the free state.

12. A system according to claim 11, wherein the central processing unit comprises means for marking all the lines of the table by changing the state of the free field of all the lines of the table, and means for initializing the free field of lines of the table selected from the physical addresses of blocks in a defective or used state.

13. A system according to claim 10, wherein the central processing unit comprises means for:
searching for the marked lines of the table, and
for each marked line, searching for a line of the table the address field of which is free, writing an address corresponding to the line marked in the free address field of the line found, and removing the marking from the marked line.

14. A system according to claim 10, wherein each line of the table comprises a state field to store the state of a block the physical address of which in the memory is supplied by the address field of the line.

15. A system according to claim 10, wherein the physical address of each block in a defective state is stored at the end of the table.

16. A system according to claim 10, wherein the memory comprises several memory zones, each memory zone being associated with a look-up table of the logic addresses and the physical addresses of the blocks belonging to the memory zone.

17. A system according to claim 16, wherein the look-up table of a memory zone is constituted upon the initialization of the system.

18. A system according to claim 16, wherein the look-up table of a memory zone is constituted upon an access to the memory zone.

19. A system according to claim 10, wherein the memory is a flash-type memory with NAND gates.

20. A system according to claim 10, further comprising a fast-access memory saving the look-up table.

21. A system according to claim 1, wherein the central processing unit and the memory are integrated into a microcontroller.

22. A computer-readable memory medium, containing instructions that, when executed, performs a method comprising:
saving for each block in a memory a state of the block, and for each used block a logic address of the block;
reading in the memory the state of each block;
storing a physical address of each block in a used state in an address field of a line of a look-up table, selected from the logic address of the block read in the memory;
storing the physical address of each block in a free state in the memory, selected from the physical address of the block in the memory;
marking a line of the table for each block in the free state in the memory; and
for each block in the free state, storing an address corresponding to each marked line of the table, in a free address field of the table.

23. The computer-readable memory medium of claim 22 wherein the computer-readable memory medium is a memory integrated into a microcontroller.

24. The computer-readable memory medium of claim 22 wherein the memory is a flash-type memory with NAND gates.

25. The computer-readable memory medium of claim 22 wherein marking a line of the table includes changing the state of a free field of the line.
